(19) United States
(12) Patent Application Publication
(10) Pub. No.: US 2010/0250647 A1
(43) Pub. Date: Sep. 30, 2010

(54) METHOD AND APPARATUS FOR TEMPLATE TO MANIPULATE WEB CONTENT

(75) Inventor: Rajeev D. Rajan, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/410,638

(22) Filed: Mar. 25, 2009

(51) Int. Cl. G06F 15/16; G06F 17/30; G06F 15/18

(52) U.S. Cl. 709/203; 707/E17.01; 706/12

(57) ABSTRACT

A method and apparatus for manipulating web content to present substantially uniform content to a client is provided. The method may comprise receiving a web content request from the client, selecting a template associated with the web content request, filtering the web content request using a dynamic filter associated with the template, transmitting the filtered web content request to a network, receiving a result associated with the transmitted filtered web content request, and mapping the result to a predefined structure associated with the template, the mapped result to be displayed to the client.

### BACKGROUND

Currently, a client (or user) may use a computing device to access the Internet for a multitude of purposes and through a multitude of channels. The client may use the Internet (“web”) as a resource for a variety of activities, such as, searching, buying products and/or services, listening to music, watching a movie, etc. Generally, the client's ability to locate goods or services on the Internet is limited by the clarity of their search, the popularity of the requested item, or the like.

Furthermore, because entities continue to expand operations on the Internet, clients are becoming inundated with information (or web content). As entities attempt to distinguish each of their products or services, the manner in which entities present information may become less uniform. Web content layout and accessibility on the Internet can vary greatly across a spectrum of web content suppliers. For example, competing mobile phone companies may present similar phones with similar features in such a manner that making a side-by-side comparison is nearly impossible for a potential consumer. Continuing the above example, the similar phones may be sold at competing retail stores, where the retail store web pages present information in a structure unique to the specific store. This again hinders the potential consumer's efforts to perform a side-by-side comparison of the two phones. As such, the ability for a client to clearly and uniformly comprehend and/or compare web content across products, across retailers, across topics, etc., is diminished.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with manipulating web content to present substantially uniform content to a client. According to one aspect, a method for manipulating web content to present substantially uniform content to a client is provided. The method can comprise receiving a web content request from the client, selecting a template associated with the web content request, filtering the web content request using a dynamic filter associated with the template, transmitting the filtered web content request to a network, receiving a result associated with the transmitted filtered web content request, and mapping the result to a predefined structure associated with the template, the mapped result to be displayed to the client.

Another aspect relates to an apparatus. The apparatus can include a client interface for receiving a web content request from the client, and selecting a template associated with the web content request, a template module, including at least one template, wherein the at least one templates are each associated with a dynamic filter, wherein the dynamic filter is used for focusing the web content request with criteria associated with the template, a communications component for transmitting the filtered web content request to a network, and receiving a result associated with the transmitted filtered web content request, and the template module, further includes a mapping module for mapping the result to a predefined structure associated with the template, the mapped result to be displayed to the client.

Yet another aspect relates to at least one processor configured to manipulate web content to present substantially uniform content to a client. The at least one processor can include a first module for receiving a web content request from the client, a second module for selecting a template associated with the web content request, a third module for filtering the web content request using a dynamic filter associated with the template, a fourth module for transmitting the filtered web content request to a network, a fifth module for receiving a result associated with the transmitted filtered web content request, and a sixth module for mapping the result to a predefined structure associated with the template, the mapped result to be displayed to the client.

Still another aspect relates to a computer program product comprising a computer-readable medium. The computer-readable medium can include a first set of codes for causing a computer to receive a web content request from a client, a second set of codes for causing the computer to select a template associated with the web content request, a third set of codes for causing the computer to filter the web content request using a dynamic filter associated with the template, a fourth set of codes for causing the computer to transmit the filtered web content request to a network, a fifth set of codes for causing the computer to receive a result associated with the transmitted filtered web content request, and a sixth set of codes for causing the computer to mapping the result to a predefined structure associated with the template, the mapped result to be displayed to the client.

Yet another aspect relates to an apparatus. The apparatus can include means for receiving a web content request from a client, means for selecting a template associated with the web content request, means for filtering the web content request using a dynamic filter associated with the template, means for transmitting the filtered web content request to a network, means for receiving a result associated with the transmitted filtered web content request, and means for mapping the result to a predefined structure associated with the template, the mapped result to be displayed to the client.

In accordance with one or more aspects and corresponding disclosure thereof, various aspects are described in connection with manipulating web content from a server to present substantially uniform content to a client. According to one aspect, a method for manipulating web content from a server to present substantially uniform content to a client is provided. The method can comprise receiving, at a server, a web content request from the client, selecting, at the server, a template corresponding to the web content request, filtering, at the server, the web content request using a dynamic filter corresponding to the template, transmitting, from the server, the filtered web content request to a network, receiving, to the server, a result corresponding to the transmitted filtered web content request, mapping the result to a predefined structure corresponding to the template, transmitting the mapped result to the client.

Another aspect relates to an apparatus. The apparatus can include a communication component for receiving a web content request from the client, and selecting a template corresponding to the web content request, a template module, including at least one template, wherein the at least one templates are each corresponding to a dynamic filter, wherein the dynamic filter is used for focusing the web content request with criteria corresponding to the template, the communications component further operable for transmitting the filtered web content request to a network, and receiving a result corresponding to the transmitted filtered web content request, the template module, further operable for mapping module for mapping the result to a predefined structure corresponding to the template, and the communications component further operable for transmitting the mapped results to the client.

Yet another aspect relates to at least one processor configured to manipulate web content to present substantially uniform content to a client. The at least one processor can include a first module for receiving, at a server, a web content request from the client, a second module for selecting, at the server, a template corresponding to the web content request, a third module for filtering, at the server, the web content request using a dynamic filter corresponding to the template, a fourth module for transmitting, from the server, the filtered web content request to a network, a fifth module for receiving, to the server, a result corresponding to the transmitted filtered web content request, a sixth module for mapping the result to a predefined structure corresponding to the template, and a seventh module for transmitting the mapped result to the client.

Still another aspect relates to a computer program product comprising a computer-readable medium. The computer-readable medium can include a first set of codes for causing a computer to receive, at a server, a web content request from the client, a second set of codes for causing the computer to select, at the server, a template corresponding to the web content request, a third set of codes for causing the computer to filter, at the server, the web content request using a dynamic filter corresponding to the template, a fourth set of codes for causing the computer to transmit, from the server, the filtered web content request to a network, a fifth set of codes for causing the computer to receive a result corresponding to the transmitted filtered web content request, a sixth set of codes for causing the computer to map the result to a predefined structure corresponding to the template and a seventh set of codes for causing the computer to transmit the mapped result to the client.

Yet another aspect relates to an apparatus. The apparatus can include means for receiving, at a server, a web content request from the client, means for selecting, at the server, a template corresponding to the web content request, means for filtering, at the server, the web content request using a dynamic filter corresponding to the template, means for transmitting, from the server, the filtered web content request to a network, means for receiving, to the server, a result corresponding to the transmitted filtered web content request, means for mapping the result to a predefined structure corresponding to the template, and means for transmitting the mapped result to the client.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of an exemplary system that can manipulate web content to present substantially uniform content to a client.

FIG. 2 is a block diagram of an exemplary template module applied to web content from various websites so as to uniformly present said content.

FIG. 3 is an exemplary method for manipulating web content to present substantially uniform content to a client through a template.

FIG. 4 is an exemplary method for presenting web content to a client through various templates.

FIG. 5 illustrates an exemplary computer device according to an aspect;

FIG. 6 depicts a block diagram of an exemplary system that can manipulate web content to present substantially uniform content to a client;

FIG. 7 illustrates an exemplary multiple access wireless communication system according to an aspect;

FIG. 8 depicts a block diagram of an exemplary communication system.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

A computing device may include various components to allow a client to access the Internet. Furthermore, the computing device may include various web browsers or the like to facilitate the client interaction with web content available over the Internet. A template module may be used in conjunction with or as a replacement for the web browser. One feature of such a template enabled web browser will be the ability to present web content in a substantially uniform manner, regardless of the origin or original format of such web content. As such, a template structure may be available for a multitude of computing devices, such as but not limited to: laptops, desktops, netbooks, handheld computing devices, smartphones, etc. In one aspect, specific templates may be made available for different makes and models of computing devices (e.g. a music search template may be tailored for a specific brand/make/model of phone).

Furthermore, in one aspect, features included in the template allow for focusing and filtering a client's initial interactions with a computing device user interface, thereby streamlining the client's experience in retrieving the desired web content. For example, a client may select a “music” template to be incorporated into a web browser, or as a stand alone product. The music template may include options that allow the client to narrow possible fields of search through application of various options or filters, such as, genre, popularity, band hometown location, upcoming band tour dates, length of song, etc. These filters may be provided to the client before a search has been initiated, thereby allowing the template to focus any subsequent search terms through the selected filters.

Furthermore, in one aspect, the template may include a learning engine to measure client metrics to further focus any subsequent search. For example, if a client has selected a filtering option repeatedly in the past, or has only selected search results that would have been more clearly found had a filter been in place, then the template may automatically apply that filter to subsequent searches. Alternatively, the template may inform the client of the availability of such a filter, so as to allow the client to select application of the filter.

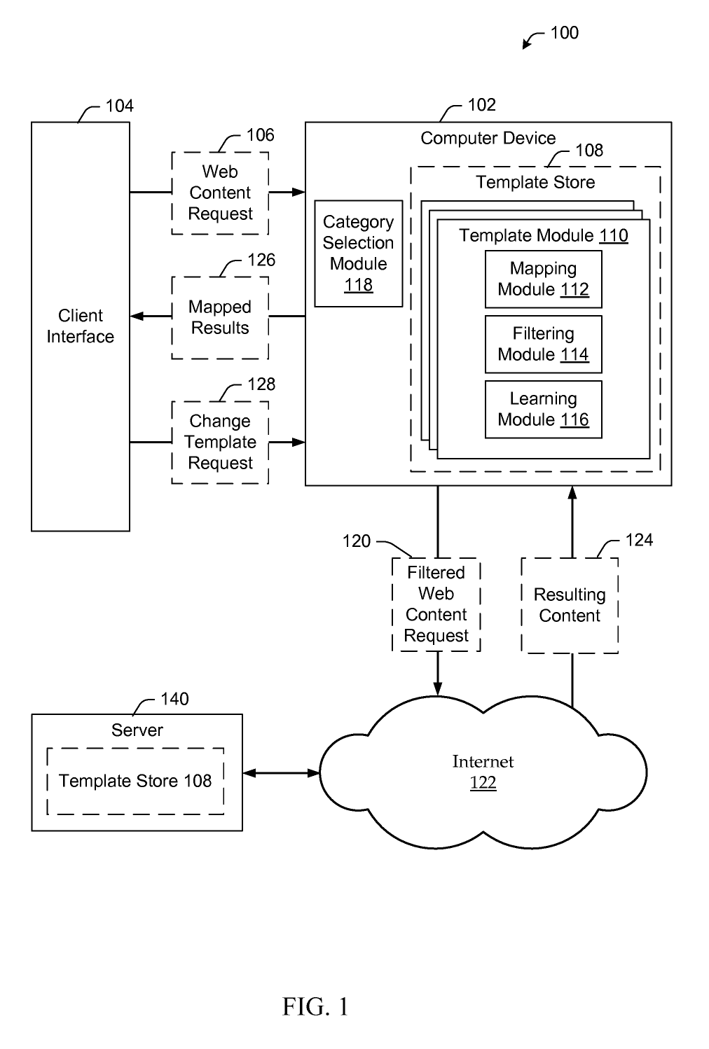

With reference now to FIG. 1, exemplary system 100 that can manipulate web content to present substantially uniform content to a client is depicted. Generally, system 100 can include a computer device 102, accessible to a client through a client interface 104. As described, supra, computer device 100, may include at least one template module 110 to assist in presenting substantially uniform web content to a client in response to a client's web content request. Template module 110 may include mapping module 112, filtering module 114 and learning module 116. Mapping module 112 may facilitate mapping of web content to through a predefined presentation structure. For example, contact information for a company may be mapped to display in a side bar. As such, the originating source of the received content and where the originating source placed contact information on their webpage becomes irrelevant as the contact information will uniformly be presented on the side bar through the template. Filtering module 114 may filter web content requests prior to transmitting the request to the Internet, thereby narrowing and focusing the request. Learning module 116 may analyze user inputs, default settings, and various user metrics to further assist both the filtering module 116 and mapping module 112 in providing the user with a desired result. Furthermore, template module 110 may be stored on the computer device in template store 108. Template store 108 may store multiple template modules 110, where each template module 110 may be designed for a specific activity or service. For example, template store 108, may store template modules designed for: searching, presenting content, presenting music, purchasing products, assisting with navigation, assisting with language translation, etc. In one aspect, template module 110 may be activated as an add-on to an existing web browser associated with computer device 102, or may be activated as a stand alone product. Furthermore, in one aspect, template module 110 may be initiated by client input. While in another aspect, template module 110 may be automatically initiated for the client.

Computer device 102 may also include category selection module 118. In one aspect, category selection module 118 allows a client to provide a template module with additional information related to topics of interest to the client. Generally speaking, a category selection may provide the template with additional context to assist in focusing interactions. For example, before a search, a client may input a category of “Summer”, and as such, subsequent searches will be focused towards results pertaining more with “Summer.” Continuing the above example, if the client were to then search for “skiing” after providing the category selection of “Summer”, then results would be focused towards water skiing rather than alpine or cross-country skiing.

In operation, a client may access computer device 102 through client interface 104. Client interface 108 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, client interface 108 may include one or more output devices, including but not limited to a display, a speaker, a haptic feedback mechanism, a printer, any other mechanism capable of presenting an output to a user, or any combination thereof. The client may input a web content request 106 through the client interface 104 that is relayed to computer device 104. In one aspect, template module 110 automatically opens prior to a client providing the web content request 106, and may prompt the client to specify additional inputs to assist filter module 114 in focusing the web content request 106. In another aspect, template module 110 may use data determined by learning module 116 to assist filter module 114 in focusing the web content request 106. In yet another aspect, filter module 114 may receive input from a selected category from the category selection module 118 to assist in focusing the web content request 106. It should be noted that the above referenced modules may work together in additional combinations, not specifically referenced, and may be located separately or housed together within computer device 102.

After filter module 114 manipulates web content request 106, the filtered web content request 120 is transmitted to an appropriate network, server or the like associated with the Internet 112. The filtered web content request 120 may cause relevant servers or the like to return resulting content 124 to computer device 104. For example, the filtered web content request 120 may include a request for music, with a filter limiting the request to a certain town as the hometown (e.g. bands from York, Pa.). As such, resulting content 124 may include a band webpage, music files for listening, retail store listings for items for sale from the band, etc.

Template module 110 receives resulting content 124 and manipulates resulting content 124 using mapping module 112 to provide a substantially uniform display experience for the client. The mapped results 126 are sent to the client interface 104 and displayed for the client. The manner in which resulting content 124 is mapped may depend at least in part on which template module 110 is active. For example, if a “music playing” template is active, then the mapped results 126 may be presented in a jukebox looking format to allow the client to listen to the web content. Alternatively, if a “purchasing” template is active, then the mapped results 126 may be displayed with purchasable content in a center panel and the retail store contact information on a side bar. By way of example, and not limitation, a purchasing template may obtain and store user information such as, name, address, credit card number, etc, and automatically insert this information into the appropriate boxes when a user makes a purchase through a website. As such, the user does not have to save his or her personal information with each of the sites form which he or she is purchasing, but rather may store the information with the purchasing template for application when desired.

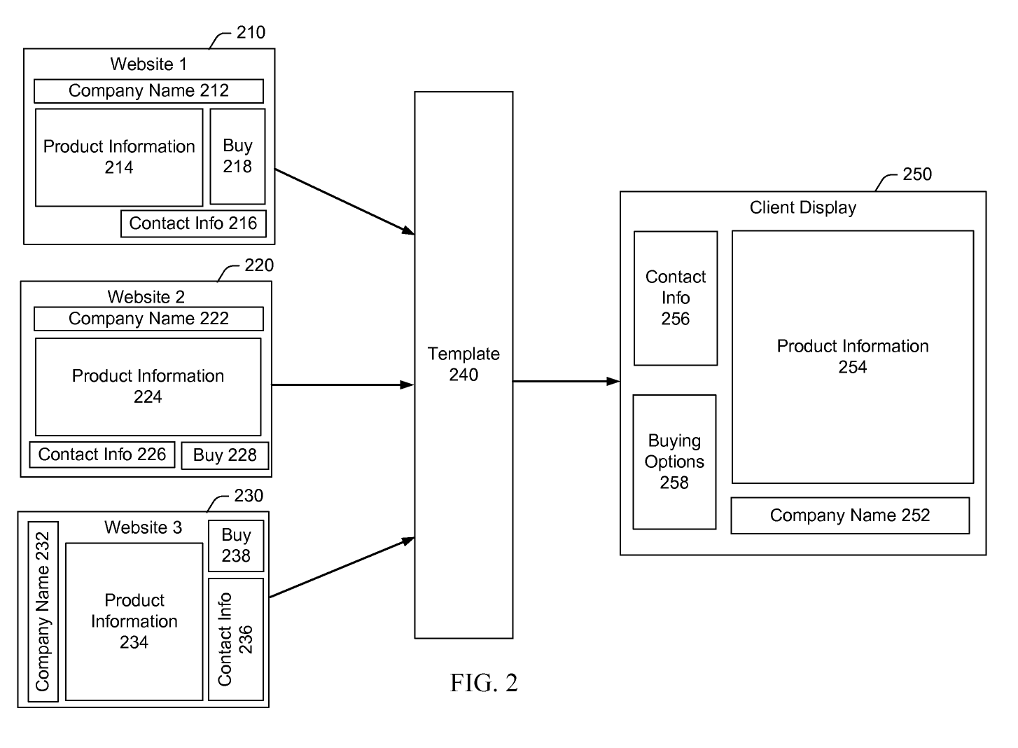

As such, the original source of the resulting content 124 may not affect how the mapped results 126 are presented. Therefore, as depicted and described in more depth below with reference to FIG. 2, content from various stores may be presented in a substantially uniform manner, thereby making processing of the information easier for the client.

In one aspect, template store 108 may reside on a server 140 communicatively coupled to the user interface 104 and or computer device 102 through a network such as the internet 122. In such an aspect, filtering of a web content request 106 and mapping results 126 may be performed at server 140 prior to the mapped resulting 126 being presented to a user. For example, a user may initiate a search for audio files. This search may be rerouted to a server so as to apply a “parental control” filter to the content thereby limiting available audio files. The presentation of the available audio files may be formatted at server and the mapped results may be relayed to the user interface. As such, the template does not reside on the user's computer device 102 thereby reducing the chance that children may be able to circumvent the “parent control” template.

Additionally, in one aspect, a client may switch between various active templates, or have multiple templates active at one time through a change template request 128. Continuing the above example, if after listening to the music the client wishes to find a good deal on a shirt with the bands logo, then the client may make a change template request 128, to switch to, or open separately, a searching template to find the specific shirt, and finally a purchasing template to facilitate buying the desired shirt. As demonstrated above, a template may be changed on the fly and a client may toggle between or cascade through various templates during various web content requests and interactions. Additionally, in one aspect, a template may be shared, purchased, borrowed, lent, etc. between users.

Furthermore, in one aspect, template module 110 may function “behind-the-scenes” such that a user may not have direct interaction with or see the template module 110. For example, an “analytics template” may monitor user search activity, purchasing habits, etc. Another example may be a “security template” that could facilitate a secure transaction either alone or in conjunction with another template.

In another aspect, template module 110 may function to control devices communicatively connected to the computing device 102. For example, a “control” template, hidden or available to the user, may control and command various devices around the computing device. As such, a “photo transfer” template on a mobile device may allow the mobile device to communicate with a digital camera and upload photos from the digital camera to the mobile device, and possibly thereafter to a website. Communication between the computing device and a peripheral device may be enabled through any number of wireless communication techniques.

Additionally, template module 110 may interact with other template modules 110 and/or other computing devices, service providers, content providers, etc. to provide additional functionalities. For example, a content provider may provide, as part of a website, additional functionalities to client templates such as the ability to combine a “product searching” template and a “produce purchasing” template while interacting with the website.

FIG. 2 illustrates a block diagram of an exemplary template module 240 applied to web content from various websites 210, 220 and 230 so as to uniformly present said content. In one aspect, websites 210, 220 and 230 include information such as, but not limited to company name (212, 222, 232), product information (214, 224, 234), contact information (216, 226, 236) and purchasing information (218, 228, 238). In one aspect, a template module 240 may designate different portions of a client display 250 for different information, where the number and size of each display area as well as the corresponding data to be mapped thereto are configurable. Furthermore, as noted above, the mapped display area of a given template module 240 may include not only resulting content from websites (e.g. 210, 220, 230, etc.) mapped into respective display areas according to the template module 240, but may further include template-specific data, such as one or more of wallpaper, icons, headings, graphics, etc. Accordingly, the layout of mapped results for a specific template module 240 is standardized, regardless of the original display area layout of the resulting content. For example: contact information 216, 226, 236 may be mapped to a standardized contact information 256 display on client display 250; product information 214, 226, 234 may be mapped to a standardized product information 254 on client display 250; company name 216, 226, 236 may be mapped to a standardized company name 252 display on client display 250; and buying options 218, 228, 238 may be mapped to a standardized buying options 258 display on client display 250.

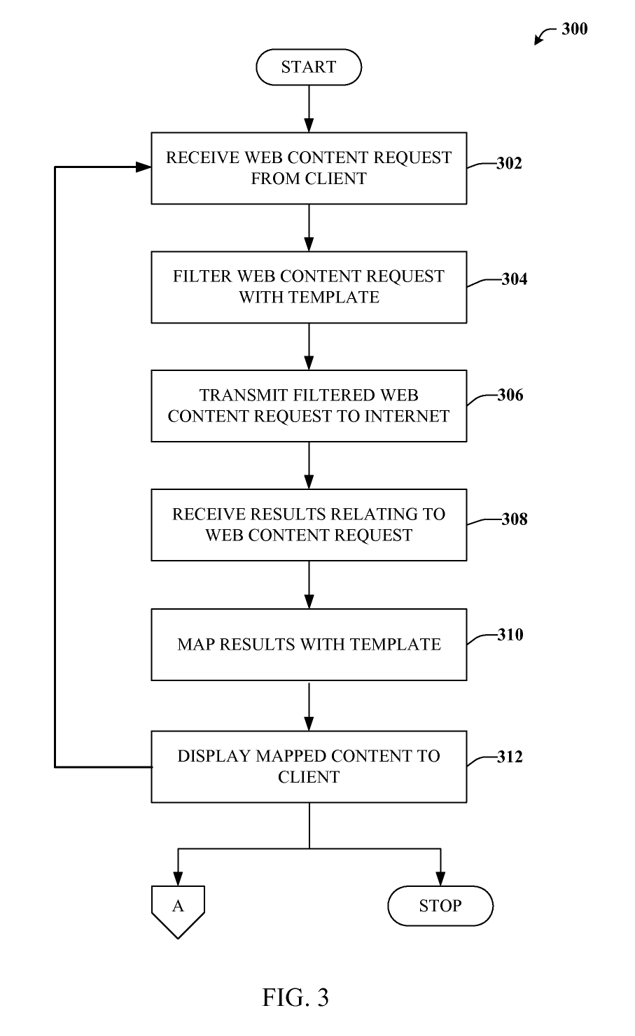

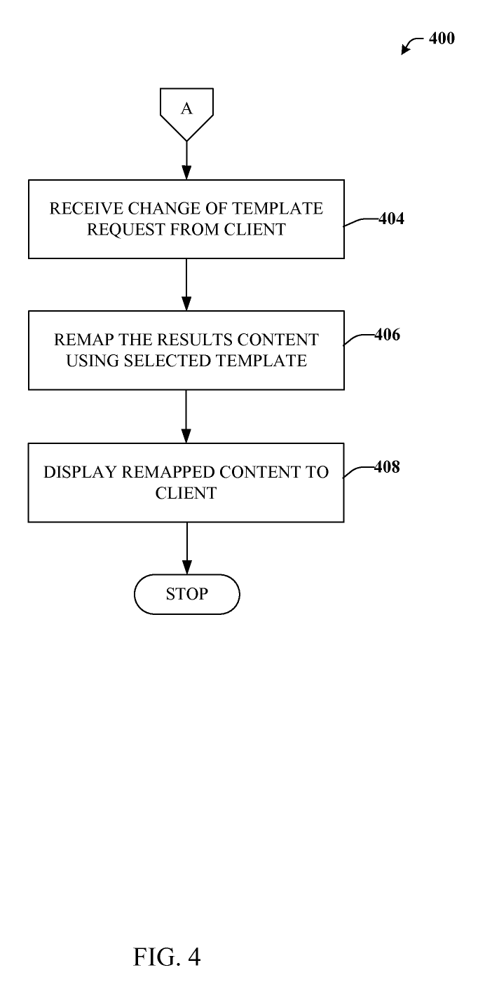

FIGS. 3 and 4 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 3, exemplary method 300 for manipulating web content to present substantially uniform content to a client through a template is illustrated. Generally, at reference numeral 302, a web content request from a client is received. Typically, the web content request is received through a client interface and may include data, instructions, files or the like from a client. Furthermore, the web content request may include predefined filters and or categories to focus the request.

Next to be described, at reference numeral 304, the web content request is filtered. In one aspect, the filter is automatically applied to the web content request based at least in part on default settings, prior client usage, or the like. In another aspect, the client may select specific filters to be applied to the web content request. At reference numeral 306, the filtered web content request is transmitted to the Internet. Generally, the request may be transmitted to a network and/or routed to an applicable server, where the request is processed and relevant content is retrieved. At reference numeral 308, results relating to the filtered web content request are received by the computing device.

At reference numeral 310, received results are mapped using at least one active template. In one aspect, the mapping of the received results includes placing results based at least in part on the content of that portion of the result into a predefined structure. For example, contact information for a company may be mapped to display in a side bar. As such, the originating source of the received content and where the originating source placed contact information on their webpage becomes irrelevant as the contact information will uniformly be presented on the side bar through the template.

At reference numeral 312, the mapped content is displayed for the client. In one aspect, when there is content that does not map to the predefined structure associated with the template the client is provided with options, including options such as, to see the full content unmapped, to see the unmapped content separately, or to not see the unmapped content. Furthermore, a client may provide a second web content request as a result, at least in part, of the mapped results displayed from the first web content request. In such an instance, method 300 may be iterated through with the second web content request from the client.

With reference to FIG. 4, exemplary method 400 for presenting web content to a client through various selected templates is illustrated. In one aspect, a template may be chosen to assist in clarifying web content for a specific purpose. For example, a music searching template may assist a client in locating various materials related to an artist on the Internet. The template may not have presented additional details through the mapped predefined structure that could be helpful to a client in contexts other than music searching. For example, the music searching template may not have mapped web content such as but not limited to: concert dates, related merchandise retailers, band member biographical information, etc. As such, the client may wish to either switch templates, or open additional templates to view web content for a different purpose. For example, after obtaining music from an artist through a music searching template, the user may wish to buy tickets to an upcoming concert in the area. In such an example, the user may switch templates or open a new template designed to assist in purchasing, thereby allowing the user to view dates and information about a concert and purchase tickets.

Generally, at reference numeral 404, a change of template request may be received from a client. In one aspect, the client may request to switch templates, thereby closing an active template and opening an inactive template. In another aspect, the client may request to open multiple templates concurrently.

At reference numeral 406, resulting web content is remapped using the selected activated template. In one aspect, multiple templates are activated in the change of template request and, as such, the results content is remapped through each of the templates. Furthermore, in one aspect, when the activated template may need additional information not found in the originally retrieved results, a secondary web content request can be automatically initiated and fulfilled. At reference numeral 408, the remapped content is displayed to the client. In one aspect, the remapped content appears concurrently with a previous templates mapped content. In another aspect, the remapped content takes the display place of the previously mapped materials.

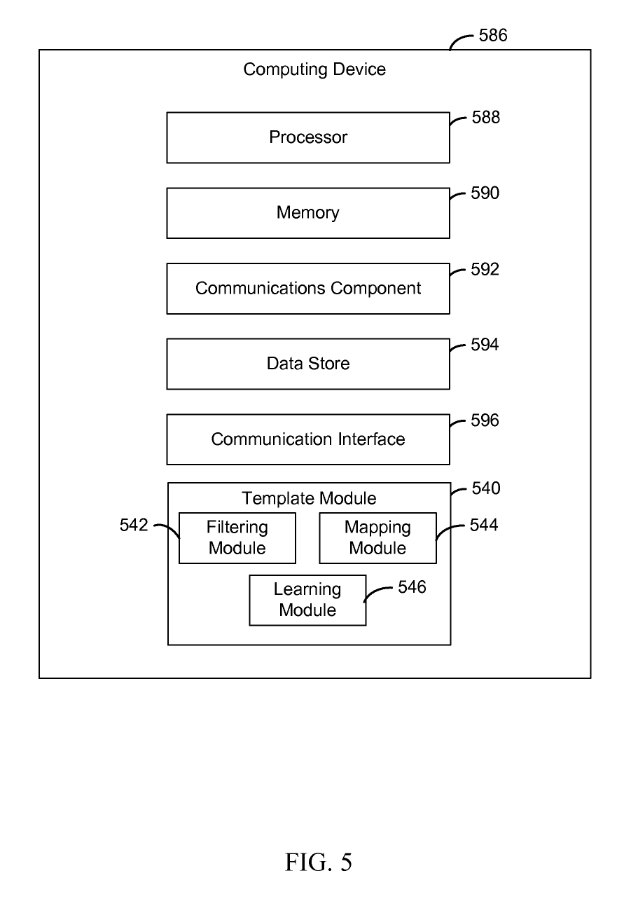

Referring to FIG. 5, in one aspect, computer device 102, and/or server 140 (FIG. 1) may be represented by computing device 586. Computing device 586 includes a processor 588 for carrying out processing functions associated with one or more of components and functions described herein. Processor 588 can include a single or multiple set of processors or multi-core processors. Moreover, processor 588 can be implemented as an integrated processing system and/or a distributed processing system.

Computing device 586 further includes a memory 590, such as for storing local versions of applications being executed by processor 588. Memory 590 can include ay type of memory usable by a computer, such as random access memory (RAM), read only memory (ROM), tapes, magnetic discs, optical discs, volatile memory, non-volatile memory, and any combination thereof.

Further, computing device 586 includes a communications component 592 that provides for establishing and maintaining communications with one or more parties utilizing hardware, software, and services as described herein. Communications component 594 may carry communications between components on computing device 86, as well as between computing device 586 and external devices, such as devices located across a communications network and/or devices serially or locally connected to computing device 586. For example, communications component 586 may include one or more buses, and may further include transmit chain components and receive chain components associated with a transmitter and receiver, respectively, operable for interfacing with external devices.

Additionally, computing device 586 may further include a data store 594, which can be any suitable combination of hardware and/or software, that provides for mass storage of information, databases, and programs employed in connection with aspects described herein. For example, data store 594 may be a data repository for applications not currently being executed by processor 588.

Computing device 586 may additionally include a communication interface component 596 (also referenced to herein as a “client interface”) operable to receive inputs from a user, and further operable to generate outputs for presentation to the user. Communication interface component 596 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, communication interface component 596 may include one or more output devices, including but not limited to a display, a speaker, a haptic feedback mechanism, a printer, any other mechanism capable of presenting an output to a user, or any combination thereof.

Computing device 586 may additionally include a template module 540 operable to manipulate web content to present substantially uniform content to a client. Template module 540 may additionally include filtering module 542, mapping module 544, and learning module 546. Filtering module 542 is operable to filter user inputs prior to transmitting the user inputs to the Internet, thereby narrowing and focusing them. Mapping module 544 is operable to map received results onto a predefined structure thereby presenting the user with substantially uniform result regardless of the results originating web site. Additionally, learning module 546 may analyze user inputs, default settings, and various user metrics to further assist both the filtering module 542 and mapping module 544 in providing the user with a desired result. In one aspect, learning module 546 may enable a template to analyze a user browsing habits, choices, etc. and at least partially in response to said analysis, keep track of activity on the internet to determine content of possible interest to the user. For example, if a user has extensively searched baseball scores for a particular team, then a template may feed content to the user relating to the team merchandize when the user opens a purchasing template or the like. Additionally, a variety of content (e.g. RSS feeds, breaking news, ads, coupons, etc.) may be provided to the user depending at least in part on prior selections and the current template selections. Learning module 546 can employ machine learning techniques and/or employ Bayesian-based probability thresholds for various features described herein and/or to provide for or aid in various inferences or determinations described herein.

Accordingly, in order to provide for or aid in the numerous inferences described herein, learning module 546 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

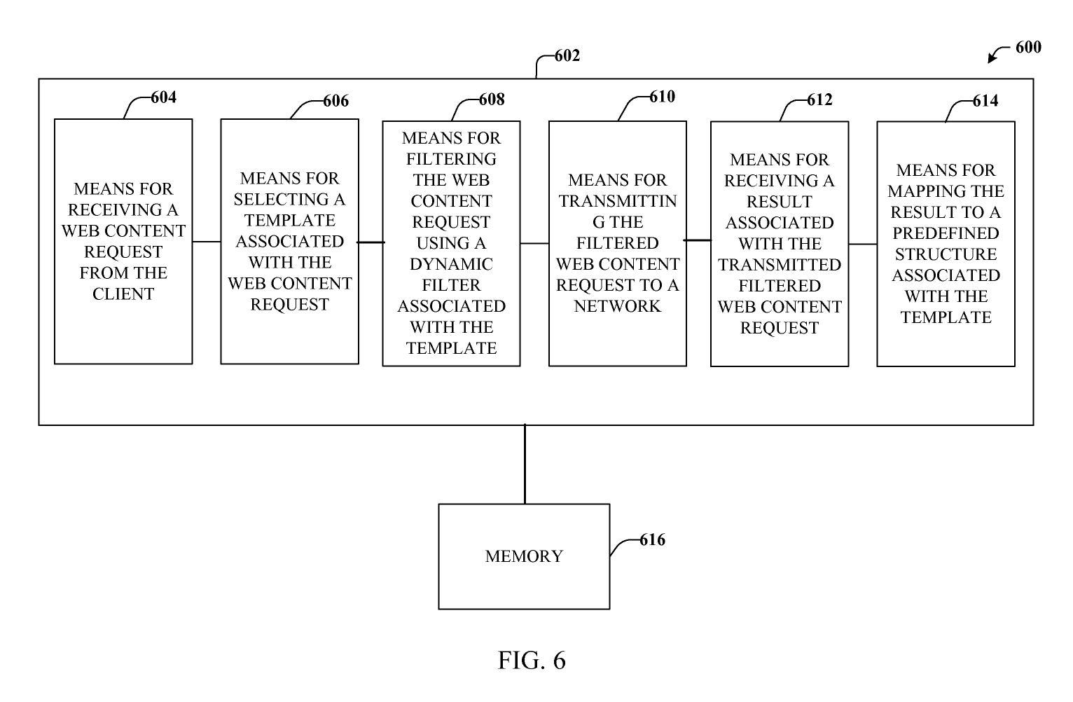

With reference to FIG. 6, illustrated is a system 600 that can manipulate web content to present substantially uniform content to a client For example, system 600 can reside at least partially within a base station, mobile device, etc. According to another example aspect, system 600 can reside at least partially within an access terminal. It is to be appreciated that system 600 is represented as including functional blocks, which can be functional blocks that represent functions implemented by a processor, software, or combination thereof (e.g., firmware). System 600 includes a logical grouping 602 of means that can act in conjunction. For instance, logical grouping 602 can include means for receiving a web content request from a client 604. For example, the web content request, as described, can include a request to search, a request for product or service information, a request to purchase products or services, a request to listen to music, a request for navigation assistance, a request for language assistance, a request to search within a specific category, etc. Further, logical grouping 602 can comprise means for selecting a template associated with the web content request 606. Thus, as described, a template may be selected by a client in association with the web content request, a set of available or related templates may be presented to the client for selection, a template may be selected automatically. Further, logical grouping 602 can comprise means for filtering the web content request using a dynamic filter associated with the template 608. For example, a template may include a history of web content requests by the client and may focus the request based in part on the history. In another aspect, a client may provide default information to allow the filter to focus the request. Further, logical grouping 602 can comprise means for transmitting the filtered web content request to a network 610. Further, logical grouping 602 can comprise means for receiving a result associated with the transmitted filtered web content request 612. Further, logical grouping 602 can comprise means for mapping the result to a predefined structure associated with the template, the mapped result to be displayed to the client 614. For example, mapping results may include mapping, based at least in part on the content of the results, into different locations on the display. In such an example, contact information for a company may be consistently mapped to a left column, while product content may be mapped to a central panel. As such, substantially uniformly presented mapped results from a web content request can be displayed to a client, irrespective of the original source of the web content. Additionally, system 600 can include a memory 616 that retains instructions for executing functions associated with the means 604, 606, 608, 610, 612, and 614. While shown as being external to memory 616, it is to be understood that one or more of the means 604, 606, 608, 610, 612, and 614 can exist within memory 616.

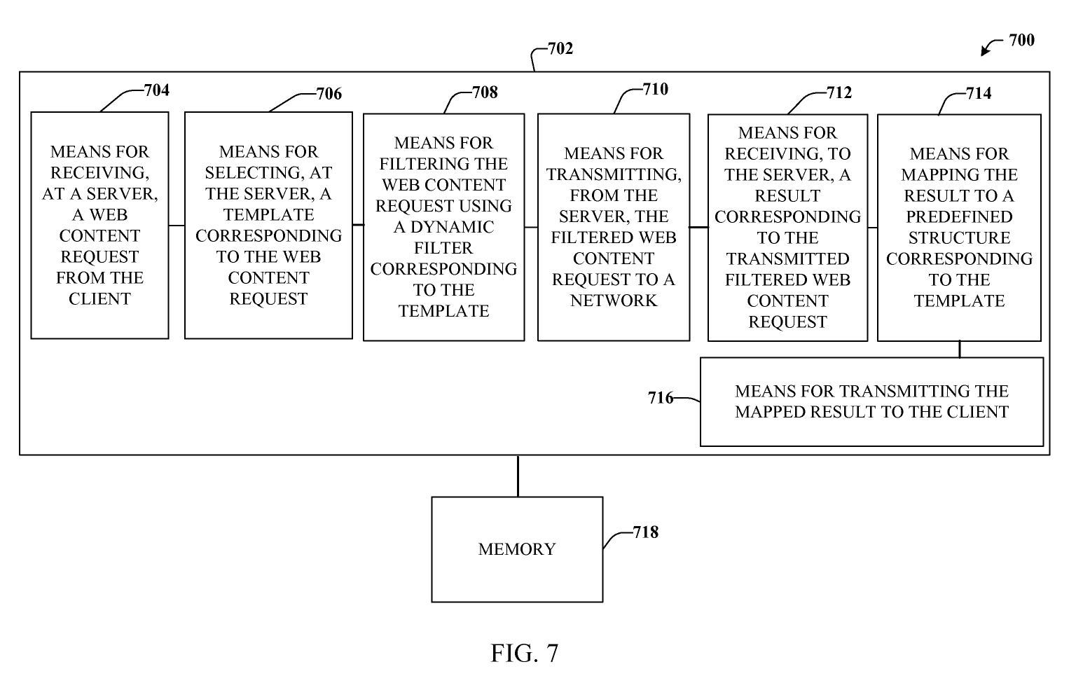

With reference to FIG. 7, illustrated is a system 700 that can manipulate web content to present substantially uniform content to a client For example, system 700 can reside at least partially within a base station, mobile device, server, etc. It is to be appreciated that system 700 is represented as including functional blocks, which can be functional blocks that represent functions implemented by a processor, software, or combination thereof (e.g., firmware). System 700 includes a logical grouping 702 of means that can act in conjunction. For instance, logical grouping 702 can include means for receiving, at a server, a web content request from the client 704. For example, the web content request, as described, can include a request to search, a request for product or service information, a request to purchase products or services, a request to listen to music, a request for navigation assistance, a request for language assistance, a request to search within a specific category, etc. Further, logical grouping 702 can comprise means for selecting, at the server, a template corresponding to the web content request 706. Thus, as described, a template may be selected by a client in association with the web content request, a set of available or related templates may be presented to the client for selection, a template may be selected automatically, etc. Further, logical grouping 702 can comprise means for filtering, at the server, the web content request using a dynamic filter corresponding to the template 708. For example, a server and/or a template may include a history of web content requests by the client and may focus the request based in part on the history. In another aspect, a client may provide default information to the server to allow the filter to focus the request. Further, logical grouping 702 can comprise means for transmitting, from the server, the filtered web content request to a network 710. Further, logical grouping 702 can comprise means for receiving, to the server, a result corresponding to the transmitted filtered web content request 712. Further, logical grouping 702 can comprise means for mapping the result to a predefined structure corresponding to the template 714. For example, mapping results may include mapping, based at least in part on the content of the results, into different locations on the display. In such an example, contact information for a company may be consistently mapped to a left column, while product content may be mapped to a central panel. Further, logical grouping 702 can comprise means for transmitting the mapped result to the client 716. As such, substantially uniformly presented mapped results from a web content request can be transmitted and displayed to a client, irrespective of the original source of the web content. Additionally, system 700 can include a memory 718 that retains instructions for executing functions associated with the means 704, 706, 708, 710, 712, 714 and 716. While shown as being external to memory 718, it is to be understood that one or more of the means 704, 706, 708, 710, 712, 714 and 716 can exist within memory 718.

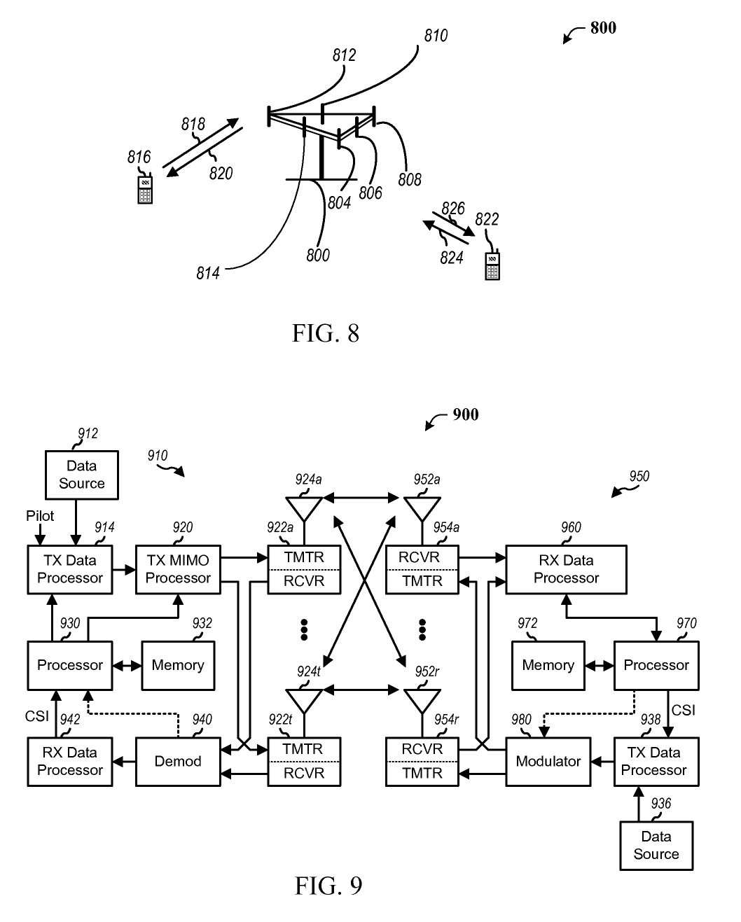

Referring to FIG. 8, computer device 102 (FIG. 1) may operate as an access terminal in a multiple access wireless communication system, which is illustrated according to one aspect. An access point 800 (AP) includes multiple antenna groups, one including 804 and 806, another including 808 and 810, and an additional including 812 and 814. In FIG. 8, only two antennas are shown for each antenna group, however, more or fewer antennas may be utilized for each antenna group. Access terminal 816 (AT) is in communication with antennas 812 and 814, where antennas 812 and 814 transmit information to access terminal 816 over forward link 820 and receive information from access terminal 816 over reverse link 818. Access terminal 822 is in communication with antennas 806 and 808, where antennas 806 and 808 transmit information to access terminal 822 over forward link 826 and receive information from access terminal 822 over reverse link 824. In a FDD system, communication links 818, 820, 824 and 826 may use different frequency for communication. For example, forward link 820 may use a different frequency than that used by reverse link 818.

Each group of antennas and/or the area in which they are designed to communicate is often referred to as a sector of the access point. In the aspect, antenna groups each are designed to communicate to access terminals in a sector, of the areas covered by access point 800.

In communication over forward links 820 and 826, the transmitting antennas of access point 800 utilize beamforming in order to improve the signal-to-noise ratio of forward links for the different access terminals 816 and 824. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a base station, a Node B, or some other terminology. An access terminal may also be called a mobile station, user equipment (UE), a wireless communication device, terminal, access terminal or some other terminology.

Referring to FIG. 9, a block diagram of an aspect of a transmitter system 910 (also known as the access point) and a receiver system 950 (also known as access terminal) in a MIMO system 900 is illustrated, where computer device 102 (FIG. 1) may be either a transmitter system or a receiver system. At the transmitter system 910, traffic data for a number of data streams is provided from a data source 912 to a transmit (TX) data processor 914.

In an aspect, each data stream is transmitted over a respective transmit antenna. TX data processor 914 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 930.

The modulation symbols for all data streams are then provided to a TX MIMO processor 920, which may further process the modulation symbols (e.g., for OFDM). TX MIMO processor 920 then provides N_{T} modulation symbol streams to N_{T} transmitters (TMTR) 922a through 922t. In certain aspects, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 922a through 922t are then transmitted from N_{T} antennas 924a through 924t, respectively.

At receiver system 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective received signal, digitizes the conditioned signal to provide samples, and further processes the samples to provide a corresponding “received” symbol stream.

An RX data processor 960 then receives and processes the N_{R} received symbol streams from N_{R} receivers 954 based on a particular receiver processing technique to provide N_{T} “detected” symbol streams. The RX data processor 960 then demodulates, deinterleaves, and decodes each detected symbol stream to recover the traffic data for the data stream. The processing by RX data processor 960 is complementary to that performed by TX MIMO processor 920 and TX data processor 914 at transmitter system 910.

A processor 970 periodically determines which pre-coding matrix to use (discussed below). Processor 970 formulates a reverse link message comprising a matrix index portion and a rank value portion.

The reverse link message may comprise various types of information regarding the communication link and/or the received data stream. The reverse link message is then processed by a TX data processor 938, which also receives traffic data for a number of data streams from a data source 936, modulated by a modulator 980, conditioned by transmitters 954a through 954r, and transmitted back to transmitter system 910.

At transmitter system 910, the modulated signals from receiver system 950 are received by antennas 924, conditioned by receivers 922, demodulated by a demodulator 940, and processed by a RX data processor 942 to extract the reserve link message transmitted by the receiver system 950. Processor 930 then determines which pre-coding matrix to use for determining the beamforming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In an aspect, Logical Traffic Channels comprises a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), a Uplink Shared Data Channel (UL-SDCH) and plurality of PHY channels. The PHY channels comprise a set of DL channels and UL channels.

The DL PHY channels may comprise:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprises:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations may apply:

AM Acknowledged Mode

AMD Acknowledged Mode Data

ARQ Automatic Repeat Request

BCCH Broadcast Control CHannel

BCH Broadcast CHannel

C- Control-

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multimedia Broadcast Multicast Service

MCCH MBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCH Physical CHannels

RACH Random Access CHannel

RLC Radio Link Control

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFITransport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN multicast broadcast single frequency network

MCE MBMS coordinating entity

MCH multicast channel

DL-SCH downlink shared channel

MSCH MBMS control channel

PDCCH physical downlink control channel

PDSCH physical downlink shared channel

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for manipulating web content to present substantially uniform content to a client, the method comprising:
receiving a web content request from the client;
selecting a template corresponding to the web content request;
filtering the web content request using a dynamic filter corresponding to the template;
transmitting the filtered web content request to a network;
receiving a result corresponding to the transmitted filtered web content request; and
mapping the result to a predefined structure corresponding to the template, the mapped result to be displayed to the client.

2. The method of claim 1, wherein selecting a template comprises:
receiving a category selection with the web content request, wherein the category selection is used by the dynamic filter to focus the web content request.

3. The method of claim 2, wherein the category selection options includes at least one of search, music, shopping, navigation, and mobile device categories.

4. The method of claim 2, wherein the category selection is used to determine the predefined structure used for mapping.

5. The method of claim 1, wherein the template is selected to facilitate a specific function.

6. The method of claim 5, wherein the specific function template including at least one of:
a music template to facilitate searching for and listening to music; or
a shopping template to facilitate searching for and goods or services; or
an analytics template to facilitate behind-the-scenes monitoring of user activities; or
a controls template to facilitate control of at least one device in communication with the client; or
a security template to facilitate secure transactions by the client.

7. The method of claim 1, wherein the predefined structure includes a defined layout of web content such that the web content is presented substantially uniformly regardless of an original layout of the result.

8. The method of claim 1, wherein selecting a template comprises:
receiving the template selection from the client prior to receiving the web content request from the client such that the selected template focuses the client web content request by formatting a client interface, used to receive the web content request, with features corresponding to the selected template.

9. The method of claim 1 further comprising:
storing data corresponding to the web content request with the template;
analyzing the stored data to refine the dynamic filter and predefined structure corresponding to the template.

10. The method of claim 9, wherein analyzing the stored data includes using a learning engine to anticipate web content preferences of a client.

11. The method of claim 1, further comprising:
determining if data corresponding to the result is not displayed as part of the mapped results;
upon a determination that data corresponding to the result is not displayed, notifying the client that data corresponding to the result was not displayed; and
providing the client with options including at least one of
selecting to view the result without mapping, or
selecting to view the non-mapped data separately, or
selecting to not view the non-mapped data.

12. The method of claim 1 further comprising:
receiving a template change request from the client, the template change request including instructions to modify the displayed content through a second template; and
remapping the received web content results using a second predefined structure corresponding to the second template.

13. The method of claim 1 further comprising:
receiving a second web content request from the client, the second web content request corresponding to the mapped results;
selecting a second template based on the second web content request;
filtering the second web content request using a dynamic filter corresponding to the second template;
transmitting the filtered second web content request to a network;
receiving a second result corresponding to the transmitted filtered second web content request; and
mapping the second result to a predefined structure corresponding to the second template, the mapped result to be displayed to the client.

14. An apparatus comprising:
a client interface for receiving a web content request from the client, and selecting a template corresponding to the web content request;
a template module, including at least one template, wherein the at least one templates are each corresponding to a dynamic filter, wherein the dynamic filter is used for focusing the web content request with criteria corresponding to the template;
a communications component for transmitting the filtered web content request to a network, and receiving a result corresponding to the transmitted filtered web content request; and
the template module, further includes a mapping module for mapping the result to a predefined structure corresponding to the template, the mapped result to be displayed to the client.

15. The apparatus of claim 14, wherein the temple module further comprises:
a category selection module for receiving a category selection with the web content request, wherein the category selection is used by the dynamic filter to focus the web content request.

16. The apparatus of claim 15, wherein the category selection module includes category selection options for at least one of search, music, shopping, navigation, and mobile device categories.

17. The apparatus of claim 15, wherein the category selection module is used to determine the predefined structure used for mapping.

18. The apparatus of claim 14, wherein the template module including a template selectable to facilitate a specific function.

19. The apparatus of claim 18, wherein the specific function template includes at least one of:
a music template to facilitate searching for and listening to music; or
a shopping template to facilitate searching for and goods or services; or
an analytics template to facilitate behind-the-scenes monitoring of user activities; or
a controls template to facilitate control of at least one device in communication with the client; or
a security template to facilitate secure transactions by the client.

20. The apparatus of claim 14, wherein the predefined structure includes a defined layout of web content such that the web content is presented substantially uniformly regardless of an original layout of the result.

21. The apparatus of claim 14, wherein the client interface further comprises:
receiving the template selection from the client prior to receiving the web content request from the client such that the selected template focuses the client web content request by formatting the client interface, used to receive the web content request, with features corresponding to the selected template.

22. The apparatus of claim 14 further comprising:
a data store for storing data corresponding to the web content request with the template;
a learning module for analyzing the stored data to refine the dynamic filter and predefined structure corresponding to the template.

23. The apparatus of claim 22, wherein analyzing the stored data includes using a learning engine to anticipate web content preferences of a client.

24. The apparatus of claim 14, wherein the mapping module is configurable to:
determine if data corresponding to the result is not displayed as part of the mapped results;
upon a determine that data corresponding to the result is not displayed, notify the client that data corresponding to the result was not displayed; and
provide the client with options include at least one of
selecting to view the result without mapping, or
selecting to view the non-mapped data separately, or
selecting to not view the non-mapped data.

25. The apparatus of claim 14, wherein
the client interface is further configurable to receive a template change request from the client, the template change request including instructions to modify the displayed content through a second template; and
the template module is further configurable to remap the received web content results using a second predefined structure corresponding to the second template.

26. The apparatus of claim 14, wherein:
the client interface is further configurable to receive a second web content request from the client, the second web content request corresponding to the mapped results, and select a second template based on the second web content request;
the template module is further configurable to filter the second web content request using a dynamic filter corresponding to the second template;
the communications component further configurable to transmit the filtered second web content request to a network, and receive a second result corresponding to the transmitted filtered second web content request; and
the template module is further configurable to map the second result to a predefined structure corresponding to the second template, the mapped result to be displayed to the client.

27. The apparatus of claim 14, wherein the apparatus includes at least one of:
a laptop computing device, or a desktop computing device, or a netbook computing device, or a handheld computing device, or a smartphone.

28. The apparatus of claim 14, wherein the template module is specifically designed for the specific apparatus upon which the template module is installed.

29. At least one processor configured to manipulate web content to present substantially uniform content to a client, the at least one processor comprising:
a first module for receiving a web content request from the client;
a second module for selecting a template corresponding to the web content request;
a third module for filtering the web content request using a dynamic filter corresponding to the template;
a fourth module for transmitting the filtered web content request to a network;
a fifth module for receiving a result corresponding to the transmitted filtered web content request; and
a sixth module for mapping the result to a predefined structure corresponding to the template, the mapped result to be displayed to the client.

30. A computer program product, comprising:
a computer-readable medium comprising:
a first set of codes for causing a computer to receive a web content request from a client;
a second set of codes for causing the computer to select a template corresponding to the web content request;
a third set of codes for causing the computer to filter the web content request using a dynamic filter corresponding to the template;
a fourth set of codes for causing the computer to transmit the filtered web content request to a network;
a fifth set of codes for causing the computer to receive a result corresponding to the transmitted filtered web content request; and
a sixth set of codes for causing the computer to map the result to a predefined structure corresponding to the template, the mapped result to be displayed to the client.

31. An apparatus, comprising:
means for receiving a web content request from a client;
means for selecting a template corresponding to the web content request;
means for filtering the web content request using a dynamic filter corresponding to the template;
means for transmitting the filtered web content request to a network;
means for receiving a result corresponding to the transmitted filtered web content request; and
means for mapping the result to a predefined structure corresponding to the template, the mapped result to be displayed to the client.

32. A method for manipulating web content from a server to present substantially uniform content to a client, the method comprising:
receiving, at a server, a web content request from the client;
selecting, at the server, a template corresponding to the web content request;
filtering, at the server, the web content request using a dynamic filter corresponding to the template;
transmitting, from the server, the filtered web content request to a network;
receiving, to the server, a result corresponding to the transmitted filtered web content request;
mapping the result to a predefined structure corresponding to the template; and
transmitting the mapped result to the client.

33. The method of claim 32, wherein selecting a template comprises:
receiving a category selection with the web content request, wherein the category selection is used by the dynamic filter to focus the web content request.

34. The method of claim 33, wherein the category selection options includes at least one of search, music, shopping, navigation, and mobile device categories.

35. The method of claim 33, wherein the category selection is used to determine the predefined structure used for mapping.

36. The method of claim 32, wherein the template is selected to facilitate a specific function.

37. The method of claim 36, wherein the specific function template including at least one of:
a music template to facilitate searching for and listening to music; or
a shopping template to facilitate searching for and goods or services; or
an analytics template to facilitate behind-the-scenes monitoring of user activities; or
a controls template to facilitate control of at least one device in communication with the client; or
a security template to facilitate secure transactions by the client.

38. The method of claim 32, wherein the predefined structure includes a defined layout of web content such that the web content is presented substantially uniformly regardless of an original layout of the result.

39. The method of claim 32 further comprising:
storing, at the server, data corresponding to the web content request with the template;
analyzing the stored data to refine the dynamic filter and predefined structure corresponding to the template.

40. The method of claim 39, wherein analyzing the stored data includes using a learning engine to anticipate web content preferences of a client.

41. The method of claim 32 further comprising:
receiving, at the server, a second web content request from the client, the second web content request corresponding to the mapped results;
selecting a second template based on the second web content request;
filtering the second web content request using a dynamic filter corresponding to the second template;
transmitting the filtered second web content request to a network;
receiving a second result corresponding to the transmitted filtered second web content request;
mapping the second result to a predefined structure corresponding to the second template; and
transmitting the mapped second result to the client.

42. An apparatus comprising:
a communication component for receiving a web content request from the client, and selecting a template corresponding to the web content request;
a template module, including at least one template, wherein the at least one templates are each corresponding to a dynamic filter, wherein the dynamic filter is used for focusing the web content request with criteria corresponding to the template;
the communications component further operable for transmitting the filtered web content request to a network, and receiving a result corresponding to the transmitted filtered web content request;
the template module, further operable for mapping module for mapping the result to a predefined structure corresponding to the template; and
the communications component further operable for transmitting the mapped results to the client.

43. The apparatus of claim 42, wherein the temple module further comprises:
a category selection module for receiving a category selection with the web content request, wherein the category selection is used by the dynamic filter to focus the web content request.

44. The apparatus of claim 43, wherein the category selection module includes category selection options for at least one of search, music, shopping, navigation, and mobile device categories.

45. The apparatus of claim 43, wherein the category selection module is used to determine the predefined structure used for mapping.

46. The apparatus of claim 42, wherein the template module including a template selectable to facilitate a specific function.

47. The apparatus of claim 46, wherein the specific function template including at least one of:
a music template to facilitate searching for and listening to music; or
a shopping template to facilitate searching for and goods or services; or
an analytics template to facilitate behind-the-scenes monitoring of user activities; or
a controls template to facilitate control of at least one device in communication with the client; or
a security template to facilitate secure transactions by the client.

48. The apparatus of claim 42, wherein the predefined structure includes a defined layout of web content such that the web content is presented substantially uniformly regardless of an original layout of the result.

49. The apparatus of claim 42 further comprising:
a data store for storing data corresponding to the web content request with the template;
a learning module for analyzing the stored data to refine the dynamic filter and predefined structure corresponding to the template.

50. The apparatus of claim 49, wherein analyzing the stored data includes using a learning engine to anticipate web content preferences of a client.

51. The apparatus of claim 42, wherein:
the communication component is further configurable to receive a second web content request from the client, the second web content request corresponding to the mapped results, and select a second template based on the second web content request;
the template module is further configurable to filter the second web content request using a dynamic filter corresponding to the second template;
the communications component further configurable to transmit the filtered second web content request to a network, and receive a second result corresponding to the transmitted filtered second web content request;
the template module is further configurable to map the second result to a predefined structure corresponding to the second template; and
The communication component is further configurable to transmit the mapped result to the client.

52. At least one processor configured to manipulate web content to present substantially uniform content to a client, the at least one processor comprising:
a first module for receiving, at a server, a web content request from the client;
a second module for selecting, at the server, a template corresponding to the web content request;
a third module for filtering, at the server, the web content request using a dynamic filter corresponding to the template;
a fourth module for transmitting, from the server, the filtered web content request to a network;
a fifth module for receiving, to the server, a result corresponding to the transmitted filtered web content request;
a sixth module for mapping the result to a predefined structure corresponding to the template; and
a seventh module for transmitting the mapped result to the client.

53. A computer program product, comprising:
a computer-readable medium comprising:
a first set of codes for causing a computer to receive, at a server, a web content request from the client;
a second set of codes for causing the computer to select, at the server, a template corresponding to the web content request;
a third set of codes for causing the computer to filter, at the server, the web content request using a dynamic filter corresponding to the template;
a fourth set of codes for causing the computer to transmit, from the server, the filtered web content request to a network;
a fifth set of codes for causing the computer to receive a result corresponding to the transmitted filtered web content request;
a sixth set of codes for causing the computer to map the result to a predefined structure corresponding to the template; and
a seventh set of codes for causing the computer to transmit the mapped result to the client.

54. An apparatus, comprising:
means for receiving, at a server, a web content request from the client;
means for selecting, at the server, a template corresponding to the web content request;
means for filtering, at the server, the web content request using a dynamic filter corresponding to the template;
means for transmitting, from the server, the filtered web content request to a network;
means for receiving, to the server, a result corresponding to the transmitted filtered web content request;
means for mapping the result to a predefined structure corresponding to the template; and
means for transmitting the mapped result to the client.
